(19) United States
(12) Patent Application Publication
(10) Pub. No.: US 2007/0008440 A1
(43) Pub. Date: Jan. 11, 2007

(54) Liquid crystal display devices

(75) Inventors: Lee-Hsun Chang, Dounan Township (TW); Chung-Jen Chenchiang, Ji-an Township (TW); Shyh-Feng Chen, Ji-an Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/236,194

(22) Filed: Sep. 27, 2005

(30) Foreign Application Priority Data
Jul. 7, 2005 (TW) 94122985

(51) Int. Cl. G02F 1/1343

(52) U.S. Cl. 349/38

(57) ABSTRACT

A liquid crystal display device comprising a plurality of scan electrodes dispose in a first direction, a plurality of data electrodes disposed in a second direction, a storage capacitor electrode, a pixel unit, and an external extending electrode. The storage capacitor electrode is disposed between two adjacent scan electrodes. The pixel unit is defined by the intersection of two adjacent scan electrodes and two adjacent data electrodes and has a pixel electrode. The external extending electrode is disposed outside the pixel unit and electrically connected to the storage capacitor electrode and one of the corresponding scan electrodes.

### BACKGROUND

The invention relates to a liquid crystal display device, and in particular to a pixel unit structure of the display device.

A conventional thin film transistor liquid crystal display (TFT-LCD) device has a display array, which can be divided into two types, Cs-on-gate type and Cs-on-common type according to the different structures of storage capacitors. In a Cs-on-gate array, a storage capacitor is formed between a pixel electrode and a previous scan electrode, that is, the reference voltage of the storage capacitor is the potential of the previous scan electrode. In a Cs-on-common array, a storage capacitor is formed between a pixel electrode and a common electrode, that is, the reference voltage of the storage capacitor is the potential of the common electrode.

FIG. 1 is a schematic diagram of a conventional Cs-on-gate array of a TFT-LCD device. The array 1 is defined by a plurality of scan electrodes G₁ to G₃ and a plurality of data electrodes D₁ and D₂. One pixel unit is defined by the intersection of scan and data electrodes, for example, a pixel unit 100 is defined by the intersection of scan electrode G₃ and data electrode D₂. The pixel unit 100 comprises a transistor (TFT), a liquid crystal capacitor Clc, and a storage capacitor Cs. Referring to FIG. 1, a gate electrode of the transistor TFT is coupled to the scan electrode G₃, and the storage capacitor Cs is coupled between a pixel electrode PE and the previous scan electrode G₂. In the same row of pixel unit, the transistors TFT are coupled to the same scan electrode, and the storage capacitors are coupled between the respective pixel electrodes and the previous scan electrode.

FIG. 2 is a schematic diagram of a conventional TFT-LCD device having a Cs-on-common structure. The array 2 is defined by a plurality of scan electrodes G₁ to G₂ and a plurality of data electrodes D₁ and D₂. A pixel unit is defined by the intersection of scan and data electrodes, for example, a pixel unit 200 is defined by the intersection of scan electrode G₂ and data electrode D₂. The pixel unit 200 includes a transistor TFT, a liquid crystal capacitor Clc, and a storage capacitor Cs. Referring to FIG. 2, a gate electrode of the transistor TFT is coupled to the scan electrode G₂, and the storage capacitor Cs is formed between a pixel electrode PE and a common electrode com. In the same row of pixel unit, the transistors TFT are coupled to the same scan electrode, and the storage capacitors are coupled between the respective pixel electrodes and the same common electrode.

FIG. 3 is a plan view of a pixel unit of a conventional Cs-on-common array. The pixel unit 200 of FIG. 2 is given as an example. The common electrode (com) is disposed between two adjacent scan electrodes G₁ and G₂ and provides common voltage Vcom. The adjacent scan electrodes G₁ and G₂ and the adjacent data electrodes D₁ and D₂ define the pixel unit 200. The pixel electrode PE covers the common electrode com. The storage capacitor Cs is formed between the pixel electrode PE and the common electrode com. An N-type transistor TFT is given as an example, a gate electrode of the transistor TFT is coupled to the scan electrode G₂, a drain electrode thereof is coupled to the data electrode D₂, and a source electrode thereof is coupled to the pixel electrode PE.

In a multi-domain vertical alignment (MVA) LCD device, a display array always uses Cs-on-common structure. Referring to FIG. 2, when the scan electrode G₂ drives the pixel cell 200, the transistor TFT is turned on, and the data electrode D₂ then transmits corresponding image data to the pixel electrode PE. At this time, the voltage of the pixel electrode PE is equal to voltage Vdata of the image data, and charges (Q) stored in the storage capacitor Cs are given by:
Q=Cs×ΔV

and
ΔV=|Vdata−Vcom|

Typically, the common voltage Vcom is generally positive, such as 5V, thus, ΔV is small. The charges stored in the storage capacitor Cs are relatively less and insufficient for the pixel unit. Thus, the response time of liquid crystal molecules is too slow, resulting in non-uniform images.

### SUMMARY

The object of the present invention is to provide a liquid crystal display device comprising a plurality of scan electrodes, a plurality of data electrodes, a storage capacitor electrode, a pixel unit, and an external extending electrode. The plurality of scan electrodes are disposed in a first direction, while the plurality of data electrodes are disposed in a second direction and intersected with the plurality of scan electrodes. The storage capacitor electrode is disposed between two adjacent scan electrodes. The pixel unit is defined by the intersecting of two adjacent scan electrodes and two adjacent data electrodes. The external extending electrode is disposed outside the pixel unit and electrically connected to one of the corresponding scan electrodes and the storage capacitor electrode.

The second object of the present invention is to provide a Liquid crystal display device comprising a plurality of scan electrodes, a plurality of data electrodes, a pixel unit, and an external extending electrode. The plurality of scan electrodes are disposed in a first direction, while the plurality of data electrodes are disposed in a second direction and intersected with the plurality of scan electrodes. The display cell is defined by the intersecting of two adjacent scan electrodes and two adjacent data electrodes. The external extending electrode is disposed outside the pixel unit and electrically connected to one of the corresponding scan electrodes. The pixel unit comprises an auxiliary electrode electrically connected to the external extending electrode and the scan electrode electrically coupled to the external extending electrode.

### DESCRIPTION OF THE DRAWINGS

The invention will become more fully understood from the detailed description given hereinbelow and the accompanying drawings, given by way of illustration only and thus not intended to be limitative of the invention.

FIG. 1 is schematic diagram of a conventional Cs-on-common array of a TFT-LCD device.

FIG. 2 is schematic diagram of a conventional Cs-on-gate array of a TFT-LCD device.

FIG. 3 is a plan view of a pixel unit of a conventional Cs-on-common array.

FIG. 4 is a plan view of an embodiment of a cell unit of an LCD device.

FIGS. 5A to 5C are plan view of embodiments of the pixel unit having auxiliary electrodes according to FIG. 4.

FIG. 6 is a plan view of an embodiment of a pixel unit of an LCD device.

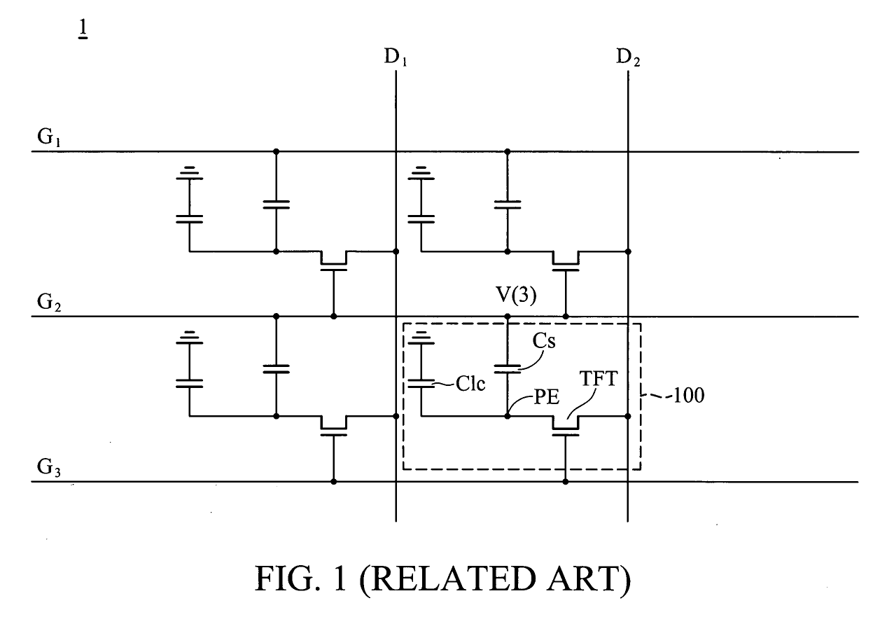

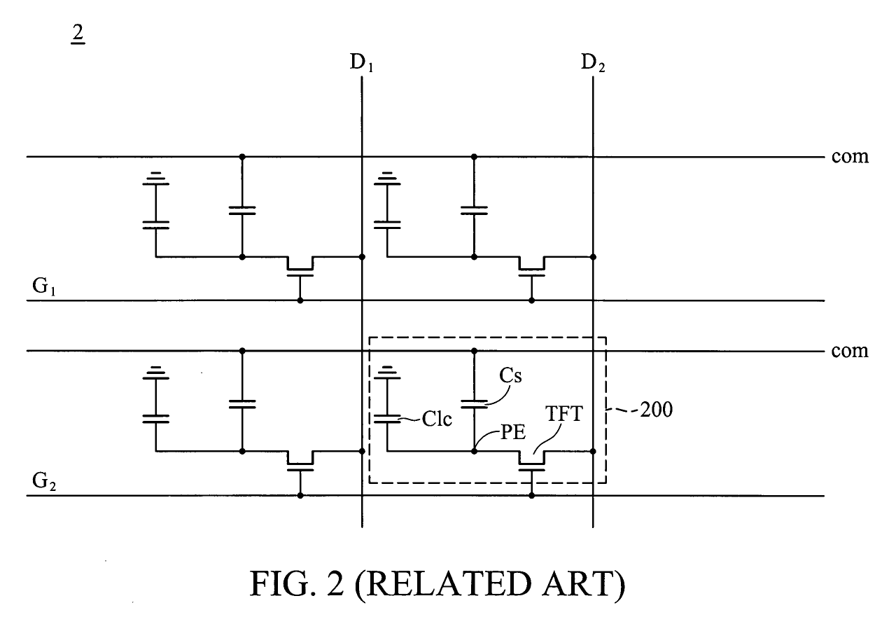

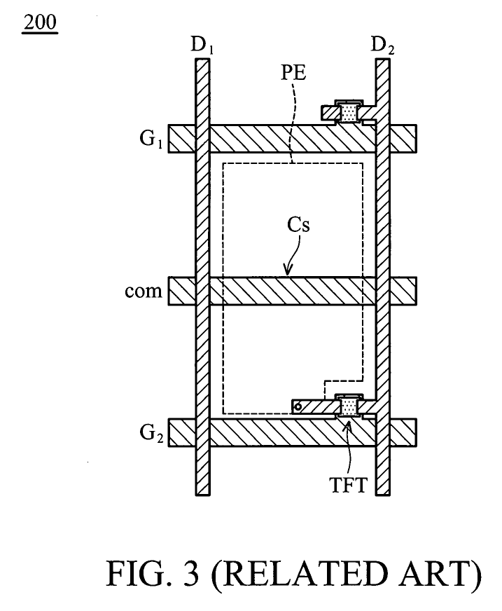

### DETAILED DESCRIPTION

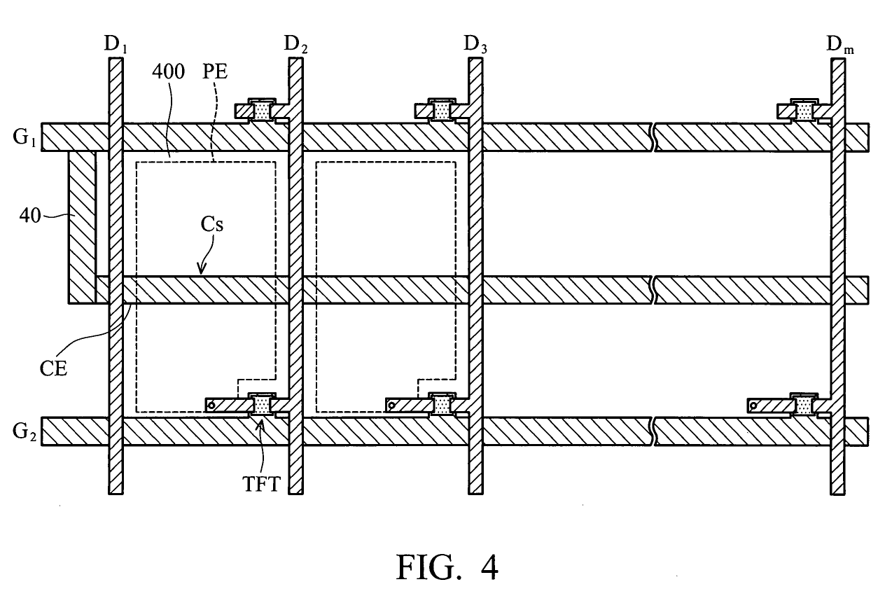

FIG. 4 depicts a top-view drawing of the first embodiment of the present invention. As shown in FIG. 4, scan electrodes G₁ and G₂ are disposed in a horizontal direction (first direction). Data electrodes D₁ to Dₘ are disposed in a vertical direction (second direction) and interlaced with the scan electrodes G₁ and G₂. Two adjacent scan electrodes G₁ and G₂ and two adjacent data electrodes define a pixel unit. For example, the scan electrodes G₁ and G₂ and the data electrodes D₁ and D₂ define a pixel unit 400. A storage capacitor electrode CE is disposed between two adjacent scan electrodes, such as G₁ and G₂. A pixel electrode PE covers the storage capacitor electrode CE. In the embodiment shown in FIG. 4, two adjacent scan electrodes, such as G₁ and G₂, and a plurality of the data electrodes D₁ and Dₘ define a row of pixel units, and the plurality of row of pixel unit form a display array. For clarity, FIG. 4 only shows one pixel unit 41.

Referring to FIG. 4, the pixel unit 400 comprises a transistor TFT and a storage capacitor Cs. In the embodiment of FIG. 4, the transistor TFT is N-type. A gate electrode (control electrode) is electrically connected to the scan electrode G₂, a drain electrode (first electrode) is electrically connected to the data electrode D₂, and a source electrode (second electrode) is electrically connected to the pixel electrode PE. The storage capacitor Cs is formed between the storage capacitor electrode CE and the pixel electrode PE. In this embodiment, an external extending electrode 40 is disposed outside the pixel unit 400 and electrically connected to the scan electrode G₁ and the storage capacitor electrode CE. In other words, the scan electrode G₁, the external extending electrode 40, and the storage capacitor electrode CE carry the same signal, that is, they have the same voltage level. When the pixel unit 400 is driven, the voltage level of the scan electrode G₁ is generally negative (above −6V). ΔV of Q=Cs×ΔV is thus increased, and the amount of charge stored in the storage capacitor Cs is increased, thus, the response time of liquid crystal molecules is accelerated and image uniformity is improved.

In this embodiment, the external extending electrode 40 is electrically connected to the scan electrode G₁ and the storage capacitor electrode CE through the pixel unit 400, which is disposed in the first position in the pixel unit row 41. It is understood that the invention is not limited thereto. According to system requirements, the external extending electrode 40 can be electrically connected to the scan electrode G₁ and the storage capacitor electrode CE through the pixel unit, which is disposed in the last position in the pixel unit row 41. Moreover, the external extending electrode 40 and the scan electrodes G₁ and G₂ are formed on the same metal layer.

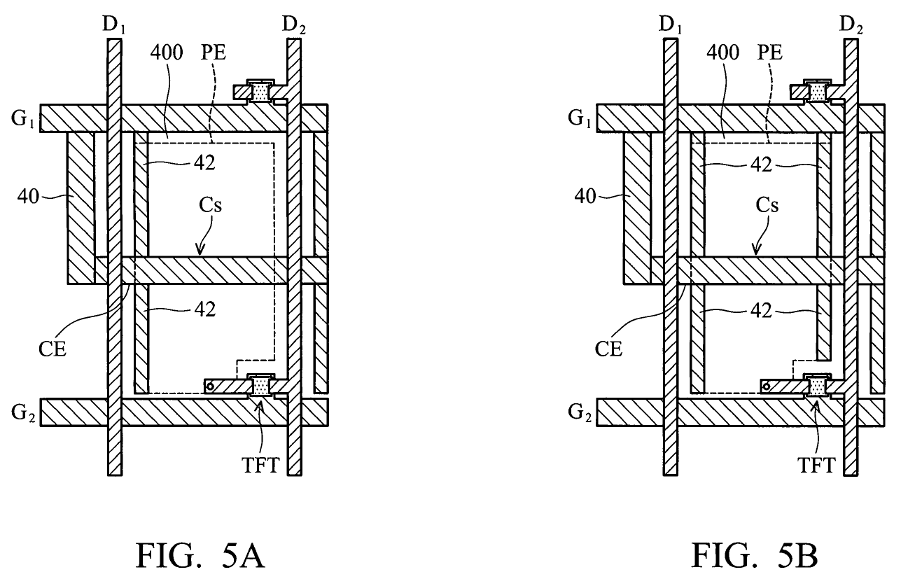

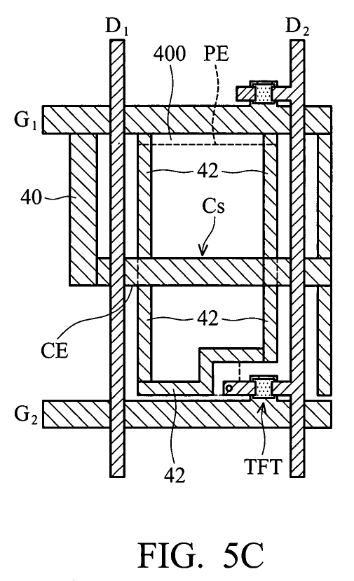

In order to enhance the stability of the structure of the storage capacitor Cs, an auxiliary electrode is disposed in each pixel unit and partly overlaps the corresponding pixel electrode therein. The structure of the auxiliary electrode can be variety as shown in FIGS. 5A to 5C. Referring to FIG. 5A, in the pixel unit 400, an auxiliary electrode 42 can be extended along one side of the pixel electrode PE, so that the scan electrode G₁ is electrically connected to the storage capacitor electrode CE. Referring FIG. 5B, the auxiliary electrode 42 can be extended along two sides of the pixel electrode PE, so that the scan electrode G₁ is electrically connected to the storage capacitor electrode CE. Referring FIG. 5C, the auxiliary electrode 42 can be extended along three sides of the pixel electrode PE.

Referring to FIGS. 4, and 5A-5C, the external extending electrode 40 is electrically connected to the scan electrode G₁ and the storage capacitor electrode CE, and the auxiliary electrode 42 is also electrically connected thereto. In other words, the auxiliary electrode 42 is electrically connected to the external extending electrode 40.

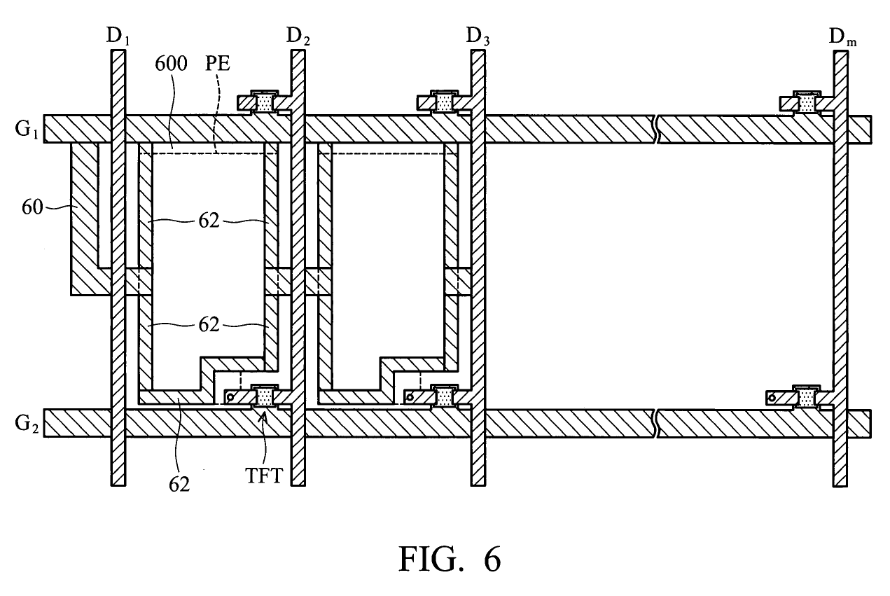

In some embodiments, as shown in FIG. 6, pixel units of LCD devices have another structure. Referring to FIG. 6, scan electrodes G₁ and G₂ are disposed in a horizontal direction (first direction). Data electrodes D₁ to Dₘ are disposed in a vertical direction (second direction) and interlaced with the scan electrodes G₁ and G₂. Two adjacent scan electrodes, such as G₁ and G₂, and two adjacent data electrodes define a pixel unit. For example, the scan electrodes G₁ and G₂ and the data electrodes D₁ and D₂ define a pixel unit 600. In the embodiment shown in FIG. 6, two adjacent scan electrodes, such as G₁ and G₂, and the data electrodes D₁ and Dₘ define a plurality of pixel units in one row, and pixel units in a plurality of rows form a display array. To describe clearly, FIG. 6 only shows one pixel unit row 61.

Referring to FIG. 6, an external extending electrode 60 is disposed outside the pixel unit 600 and electrically connected to the scan electrode G₁. An auxiliary electrode is disposed in each pixel unit and partly overlaps a corresponding pixel electrode PE which cover the pixel unit. In the pixel unit 600, an auxiliary electrode 62 can be extended along at least one side of the pixel electrode PE and electrically connected to the external extending electrode 60 and the scan electrode G₁. Take FIG. 6 as an example, the auxiliary electrode 62 extending along three sides of the pixel electrode PE.

As shown in FIG. 6, the pixel unit 600 comprises a transistor TFT and a storage capacitor Cs. In the embodiment shown in FIG. 6, the transistor TFT is N-type. A gate electrode (control electrode) is electrically connected to the scan electrode G₂, a drain electrode (first electrode) is electrically connected to the data electrode D₂, and a source electrode (second electrode) is electrically connected to the pixel electrode PE. The storage capacitor Cs is formed between the auxiliary electrode 62 and the pixel electrode PE. Since the auxiliary electrode 62 is electrically connected to the scan electrode G₁, they have the same voltage level. When the pixel unit 600 is driven, the voltage level of the scan electrode G₁ is generally negative (above −6V). ΔV of Q=Cs×ΔV is thus increased, and the amount of charges stored in the storage capacitor Cs is increased, thus, the response time of liquid crystal molecules is accelerated and image uniformity is improved.

In this embodiment, the external extending electrode 60 is electrically connected to the scan electrode G₁ and the auxiliary electrode 62 through the pixel unit 600, which is disposed in the first position in the pixel unit row 61. It is understood that the invention is not limited thereto. According to system requirements, the external extending electrode 60 can be electrically connected to the scan electrode G₁ and the auxiliary electrode 62 through the pixel unit, which disposed in the last position in the pixel unit row 61.

While the invention has been described in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display device comprising:
a plurality of scan electrodes disposed in a first direction;
a plurality of data electrodes disposed in a second direction and interlaced with the scan electrodes;
a storage capacitor electrode disposed between two adjacent scan electrodes;
a pixel unit defined by the intersection of two adjacent scan electrodes and two adjacent data electrodes; and
an external extending electrode disposed outside the pixel unit and electrically connected to one of the corresponding scan electrodes and the storage capacitor electrode.

2. The liquid crystal display device as claimed in claim 1, wherein the external extending electrode and the corresponding scan electrode are made of the same metal layer.

3. The liquid crystal display device as claimed in claim 1, wherein the external extending electrode and the corresponding scan electrode carry the same signal.

4. The liquid crystal display device as claimed in claim 1, wherein the pixel unit comprises an auxiliary electrode electrically connected to the storage capacitor electrode and the scan electrode which is electrically coupled to the external extending electrode.

5. The liquid crystal display device as claimed in claim 4, wherein the auxiliary electrode is disposed along at least one side of the pixel electrode.

6. The liquid crystal display device as claimed in claim 5, wherein the auxiliary electrode at least partly overlaps the pixel electrode.

7. The liquid crystal display device as claimed in claim 1, wherein the pixel unit comprises an auxiliary electrode electrically connected to the external extending electrode.

8. The liquid crystal display device as claimed in claim 7, wherein the auxiliary electrode is disposed along at least one side of the pixel electrode.

9. The liquid crystal display device as claimed in claim 8, wherein the auxiliary electrode partly overlaps the pixel electrode.

10. A liquid crystal display device comprising:
a plurality of scan electrodes disposed in a first direction;
a plurality of data electrodes disposed in a second direction and interlaced with the scan electrodes;
a pixel unit defined by the intersection of two adjacent scan electrodes and two adjacent data electrodes; and
an external extending electrode disposed outside the pixel unit and electrically connected to one of the corresponding scan electrodes;
wherein the pixel unit comprises an auxiliary electrode electrically connected to the external extending electrode and the scan electrode electrically coupled to the external extending electrode.

11. The liquid crystal display device as claimed in claim 10, wherein the auxiliary electrode is disposed along at least one side of the pixel electrode.

12. The liquid crystal display device as claimed in claim 11, wherein the auxiliary electrode partly overlaps the pixel electrode.
